(19) United States
(12) Patent Application Publication
(10) Pub. No.: US 2003/0015889 A1
(43) Pub. Date: Jan. 23, 2003

(54) Method for actuation of a convertible top

(76) Inventors: Klaus Stolle, Schwabniederhofen (DE); Frank Van De Poel, Rottenburg (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/195,384

(22) Filed: Jul. 16, 2002

(30) Foreign Application Priority Data
Jul. 23, 2001 (DE) 10135808.3

(51) Int. Cl. B60J 7/20

(52) U.S. Cl. 296/107.08

(57) ABSTRACT

A method and apparatus for the actuation of a convertible top system on vehicles whereby the convertible top may be received in its resting position in a compartment that is securable by a cover and whereby the convertible top may be unfolded and secured after opening of the cover, for which purpose there are controllable drive elements provided for the cover and the convertible top. The cover (1) and the convertible top (3) are essentially moved in a parallel manner under certain operational conditions to realize a loading-assistance function in a simple and functionally flexible manner, whereby the convertible top (3) remains in its resting, folded position. The control arrangement for the drive elements of the convertible top system is provided thereby with a switch position in which only one drive element (5) or a group of drive elements is triggered, which lifts the cover (3) from its resting position.

### BACKGROUND OF THE INVENTION

1. Field of the Invention

The invention relates to a method for actuation of a convertible top whereby the convertible top may be received in its resting position, possibly in a folded condition, in a compartment that is securable by a cover and whereby the convertible top may be unfolded and secured after opening of the cover, and it relates as well to an arrangement for actuation of a convertible top system in vehicles, possibly including a plurality of convertible top elements moving opposite one another, and including a securable compartment that my be opened by a cover to receive the convertible top in its resting position whereby the convertible top elements are preferably arranged in a folded condition, and a controllable drive unit for the convertible top and the cover.

2. The Prior Art

In modern convertibles, the automatically actuated convertible top is often times not stored in its folded condition in a separate compartment, but it is stored in the interior space of the vehicle that is used as a luggage compartment. The space available for loading of the luggage compartment is thereby considerably reduced, therefore it is proposed for the simplification of loading to lift the convertible top similar to the trunk lid, which is to be performed also with automatic assistance based on its weight and the unfavorable leverage condition of kinematics of the convertible top.

It is therefore the object of the present invention to provide a method for control of the convertible top and to provide an arrangement for actuation of a convertible top system in vehicles, which realizes, in a simple and functionally flexible manner, a loading-assistance function in vehicles having convertible tops stored inside the luggage compartment in a folded condition.

### SUMMARY OF THE INVENTION

The inventive control of the convertible top is characterized for achievement of this object in that the convertible top and the cover (trunk lid) are moved essentially parallel during specific operational conditions whereby the convertible top remains in its resting, possibly folded, position. The parallel movement relates thereby to the spatial components of the movement whereby the lifting of the folded convertible top leads thereby to an enlargement of the opening available for loading the luggage compartment after manual opening of the cover, e.g., the trunk lid, or opening with a switch actuating the trunk lid.

During the movement phase of the convertible top, the cover is pivoted about a first vehicle-attached axis and the convertible top is pivoted about a second vehicle-attached axis whereby the first vehicle-attached axis and the second vehicle-attached axis lie essentially parallel to one another. This type of method allows the largest opening for the luggage compartment and its optimum accessibility in a simple design.

For the timely sequence of the movement of the truck lid, or any cover, it is proposed, according to an additional characteristic of the invention, that the cover and the convertible top are moved essentially at the same time or in sequence, one after the other.

For achievement of the aforementioned object, the apparatus is characterized in its simplest embodiment in that the control arrangement has a switch position for the drive elements of the convertible top system in which only one element or a group of drive elements is triggered, which lifts the convertible top from its resting position. A hydraulic system for actuation of the convertible top is advantageously proposed, including hydraulic actuators, valves, regulating and controlling elements, etc., which are actuated in a specific sequence to open and to close the convertible top.

According to an advantageous embodiment of the invention, the control apparatus is connected to an electronic control unit, which frees the control of the drive elements or the group of drive elements as soon as the compartment cover for the convertible top is opened.

The compartment for the convertible top is thereby preferably a part of the luggage compartment of the vehicle, and according to an advantageous embodiment, the cover for the luggage compartment is at the same time the cover for the compartment of the convertible top.

According to the invention, a hydraulic cylinder, preferably a single-action hydraulic working cylinder, can be provided in an advantageous manner as a drive element for the automatic actuation of the convertible top in cooperation with the loading-assistance function of the existing system. Since the downward movement of the convertible top is effected by its own weight, a single-action cylinder is sufficient for this basic function.

To guarantee an emergency holding function for the raised convertible top during electric power failure or similar-acting malfunctions of the hydraulic system, there is advantageously proposed, according to an additional characteristic of the invention, that the working cylinder is connected to the pressure medium source via a non-electric closed valve, preferably a 3/2-way seat valve.

A check valve, closing toward the pressure medium source, is inserted advantageously between the pressure medium source and the valve for additional safety.

A mechanically simple design, which nevertheless ensures the best possible opening for loading the luggage compartment, is provided in an embodiment according to additional characteristics of the invention whereby the cover is pivotable about the first vehicle-attached axis and the convertible top is pivotable about a second vehicle-attached axis, and whereby the first vehicle-attached axis and the second vehicle-attached axis lie essentially parallel to one another.

Depending on available space and the kinematics of the convertible top itself, the drive element or the group of drive elements may directly engage the convertible top—or the drive element or the group of drive elements may engage in a preferred manner a lever connected to at least one element of the convertible top whereby it is preferably a lever arm that extends past the second vehicle-attached axis opposite the convertible top.

In the following description, an embodiment example of the invention is described in more detail with the aid of accompanying drawings.

### BRIEF DESCRIPTION OF THE DRAWINGS

FIG. 1 shows a schematic side view of a system according to the invention, and

FIG. 2 shows the portion of the hydraulic circuit diagram for the loading-assistance system in FIG. 1.

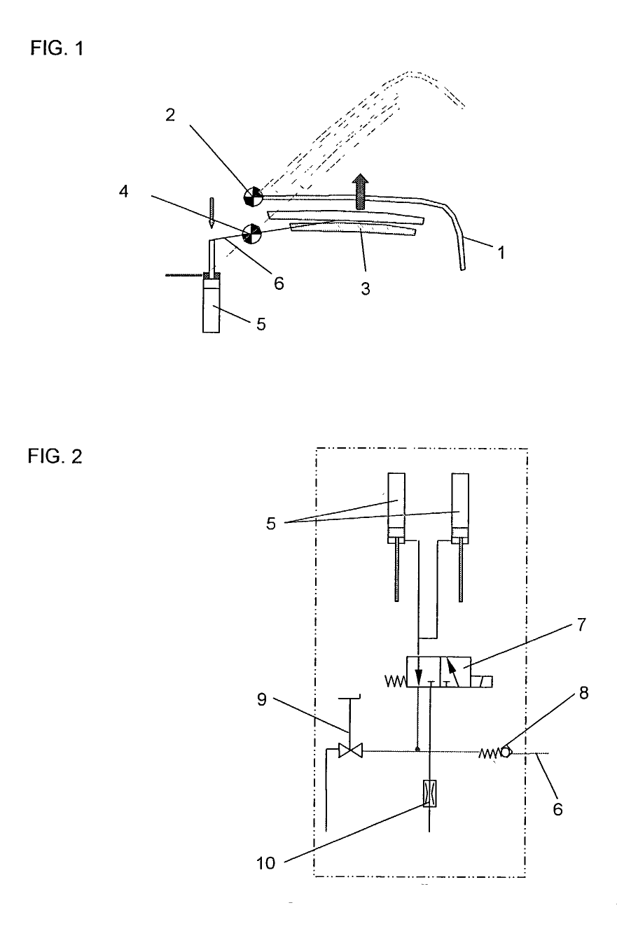

### DETAILED DESCRIPTION OF THE PREFERRED EMBIODIMENT

A luggage department or a similar compartment of a vehicle may be secured by means of a cover, e.g. a trunk lid 1, whereby the trunk lid 1 is swivelable about a swivel axis 2 essentially horizontal and perpendicular to the vehicle axis from the closed position, illustrated by solid lines, to the open position, indicated by broken lines, and visa-versa. Movement of the trunk lid 1 may be performed thereby manually by engaging the hydraulic system or it may be performed automatically in another fashion.

The foldable convertible top 3 is stored in the luggage compartment of the vehicle in a folded or layered condition. The convertible top is preferably swivelable about a second axis 4 that is essentially parallel to the trunk lid 1 to simplify loading of the luggage compartment. The second axis 4 of the convertible top is thereby advantageously offset, parallel and toward the bottom of the vehicle, and possibly slightly in the direction of the vehicle center compared to the first axis 2 of the trunk lid 1.

While the trunk lid 1 could be exclusively actuated manually as well, the actuation of the folded convertible top 3 is interconnected, of course, to the hydraulic system of the vehicle; however, it should be advantageously connected to the actuation system of the vehicle top 3 itself for opening and closing. At least one hydraulic working cylinder 5 is provided for this purpose, advantageously a single-action cylinder, which may be biased by the pressure medium on the rod-side and which then advantageously engages a lever 6 projecting past the second axis 4 of the convertible top 3. After the trunk lid 1 has opened, or at the same time, the working cylinder 5 lifts the convertible top 3 from the stored position, illustrated by solid lines, into the position shown by broken lines whereby the convertible top 3 remains nevertheless in a folded condition. The working cylinder 5 overcomes thereby the weight of the convertible top 3 and the unfavorable leverage condition at the main drive. The weight of the convertible top 3 pulls thereby on the working cylinder 5 in its extending direction and the load lies then on the rod-side ring surface of its piston.

The circuit diagram described in the following, in conjunction with FIG. 2, is provided to ensure an emergency holding function for the convertible top 3 in a raised position during possible electric power failure or similar malfunctions. As it can be seen in FIG. 2, two working cylinders 5 may be provided for realization of the loading-assistance function, which prevents twisting through torque introduction at both sides of the convertible top 3 relative to the longitudinal vehicle axis and convertible top axis, which permits secure and uniform operation. Both working cylinders 5 are connected to the hydraulic system of the vehicle via a pressure line 6 to a separate pressure medium source whereby its control occurs via an advantageous non-electric closed 3/2-way seat valve. Non-electric open valves would also be possible whereby the weight of the convertible top 3 is then taken up by the preferably spring-loaded check valve 8 that closes in the direction of the pressure medium source. The downward movement of the convertible top 3 may be performed through the manual emergency operation 9 during hydraulic system failure or electric power failure whereby the pressure medium may be diverted preferably into the pressure medium reservoir. Additional pressure medium is also diverted into this pressure medium reservoir that is pushed out of the valve 7 during normal operation of the working cylinder 5, whereby a flow control valve 10 is advantageously inserted into the line leading from valve 7 to the pressure medium reservoir to throttle the movement and/or to limit the velocity of the pressure medium flow.

We claim:

1. A method for actuation of a convertible top whereby said convertible top may be received in its resting, folded position in a compartment that is securable by a cover and whereby said convertible top may be unfolded and secured after opening of said cover, including the step of moving the convertible top and the cover essentially parallel during specific operational conditions whereby the convertible top remains in its folded resting position.

2. A method according to claim 1, wherein said cover is pivoted about a first vehicle-attached axis and said convertible top is pivoted about a second vehicle-attached axis whereby both vehicle-attached axes lie essentially parallel to one another.

3. A method according to claim 1, wherein said cover and said convertible top are moved essentially at the same time or in sequence, one after the other.

4. An apparatus for actuation of a convertible top system in vehicles consisting of a plurality of convertible top elements moving opposite one another, a securable compartment that my be opened by a cover to receive the convertible top in its resting position, whereby said convertible top elements are arranged in a folded condition, and a controllable drive element for said convertible top and said cover, wherein the control apparatus has a switch position for the drive elements of said convertible top system in which only one element or a group of drive elements is triggered, which lifts said convertible top from its resting position.

5. An apparatus according to claim 4, wherein said control arrangement is connected to an electronic control unit, which frees the control of the drive elements or the group of drive elements as soon as the compartment cover for said convertible top is opened.

6. An apparatus according to claim 4, wherein the compartment for said convertible top is a part of the luggage compartment of the vehicle.

7. An apparatus according to claim 6, wherein the cover for the luggage compartment is at the same time the cover for the compartment of said convertible top.

8. An apparatus according to claim 7, wherein a hydraulic cylinder is provided as a drive element.

9. An apparatus according to claim 8, wherein said hydraulic cylinder is a single-action hydraulic working cylinder.

10. An apparatus according to claim 8, wherein said working cylinder is connected to the pressure medium source via a non-electric closed valve.

11. An apparatus according to claim 10, wherein said valve is a 3/2-way seat valve.

12. An apparatus according to claim 11, wherein a check valve, closing toward the pressure medium source, is inserted between said pressure medium source and said valve.

13. An apparatus according to claim 12, wherein said cover is swivelable about the first vehicle-attached axis and said convertible top is swivelable about a second vehicle-attached axis, and whereby both vehicle-attached axes lie essentially parallel to one another.

14. An apparatus according to claim 13, wherein the drive element or the group of drive elements directly engages said convertible top.

15. An apaaratus according to claim 14, wherein the drive element or the group of drive elements engages a lever connected to at least one element of said convertible top whereby it is a lever arm that extends past the second vehicle-attached axis opposite said convertible top.
